(19) United States
(12) Patent Application Publication
(10) Pub. No.: US 2026/0084062 A1
(43) Pub. Date: Mar. 26, 2026

(54) Numerical Word Guessing Game

(71) Applicant: David Peter Krzemienski, Irvington, NY (US)

(72) Inventor: David Peter Krzemienski, Irvington, NY (US)

(21) Appl. No.: 19/308,211

(22) Filed: Aug. 23, 2025

Related U.S. Application Data
(60) Provisional application No. 63/697,557, filed on Sep. 22, 2024.

(51) Int. Cl. A63F 13/80; A63F 13/52; A63F 13/533

(52) U.S. Cl. CPC A63F 13/80; A63F 13/52; A63F 13/533

(57) ABSTRACT

A word guessing game is disclosed in which each letter of an alphabet is assigned a numeric value corresponding to its position in the alphabet. A puzzle word of predetermined length is selected, and a target sum equal to the total of the letter values is presented to a player as an initial clue. The player submits guess words, and the system calculates their numeric sums while identifying any letters shared with the puzzle word. Feedback is provided indicating the relative numeric positions of found letters versus other puzzle word letters, including minimum, maximum, and intermediary positions, thereby guiding the player toward the solution. The invention combines language and numeric analysis to create a strategic puzzle format applicable to digital and physical platforms, with embodiments including mobile applications, web interfaces, multiplayer competition, and three-dimensional environments.

### CROSS-REFERENCE TO RELATED APPLICATIONS

This application claims the benefit of U.S. Provisional Patent Application No. 63/697557, filed Sep. 22, 2024, under 35 U.S.C. § 119(e). The entire disclosure of the foregoing application is incorporated by reference herein.

### BACKGROUND OF THE INVENTION

Word puzzle games have long been a popular form of entertainment, challenging players to identify words through hints and guesses. Traditional word games primarily focus on letter positioning and patterns, but few, if any, combine numeric analysis with word guessing. This invention integrates language, mathematical calculations, logic, and strategic guessing, providing an engaging and unique approach to word puzzles.

### SUMMARY OF THE INVENTION

The invention is a numerical word guessing game where each letter of the alphabet is assigned a numeric value corresponding to its position in the alphabet (A=1, B=2, C=3, . . . Z=26). The game begins with a puzzle word selected and hidden from the player, and the player is given the sum of the puzzle word's letters as an initial clue. The player submits guesses, and the system calculates the sum of each guess, identifies correct letters, and provides feedback on their relative numeric positions (minimum, maximum, and intermediaries). The combination of letter identity, numeric value, and numeric relationships creates a strategic puzzle not present in traditional word games.

### BRIEF DESCRIPTION OF THE DRAWINGS

FIG. 1 is a diagram of the initial state of the game.

FIG. 2 is a diagram of the game state as a guess word is entered.

FIG. 3 is a diagram of the game state after the first submitted guess word.

FIG. 4 is a diagram of the game state after the second submitted guess word.

FIG. 5 is a diagram of the game state after a near-solution guess is submitted.

FIG. 6 is a diagram of the game state after the correct guess is submitted.

FIG. 7 is a flowchart of the game logic.

FIG. 8 is a system architecture diagram.

### DETAILED DESCRIPTION OF THE INVENTION

The following description is illustrative and not limiting. Like elements may share reference numerals across figures.

### Game Setup

Each letter of the alphabet corresponds to its position in the alphabet (A=1, B=2, C=3, . . . Z=26). The game is initialized with a hidden puzzle word from a predefined word list. The player is given the sum of the numeric values of the letters in the puzzle word as an initial hint.

### Gameplay

The player has a fixed number of guesses to determine the puzzle word. The game provides feedback on the guessed letters within guessed words. If a letter from the guessed word is present in the puzzle word, the game identifies it and reveals that letter's relative numeric position among all the letters of the puzzle word. Specifically, it reveals the letter in the smallest value position (Min), the largest value position (Max), and each position that falls between the Min and the Max. The feedback helps the player make more informed guesses in subsequent turns. The goal is to use the combination of all numeric hints and positional feedback to correctly guess the word within the given amount of guesses.

### Example

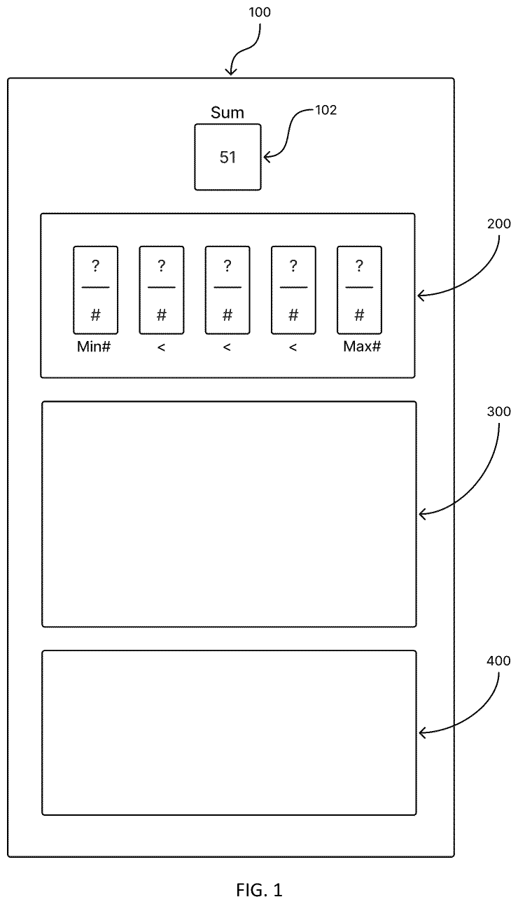

Puzzle Initialization (see FIG. 1). (1) The puzzle word is GREAT (G=7, R=18, E=5, A=1, T=20); this is hidden from the player at the start of the game. (2) The target sum is 51 (7+18+5+1+20 =51); this is provided to the player at the start of the game.

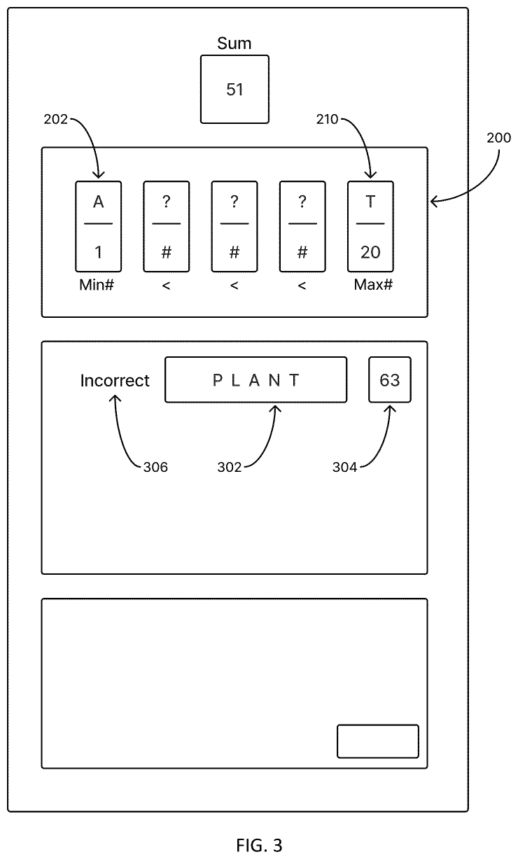

Player's Guess 1: PLANT (P=16, L=12, A=1, N=14, T=20) (see FIG. 3). (1) The game informs the player the guess sum is 63. (2) The game informs the player that “A” and “T” are in the word. (3) A=1 is in the smallest value (Min) position. (4) T=20 is in the largest value (Max) position. (5) The game informs the player the word is not correct.

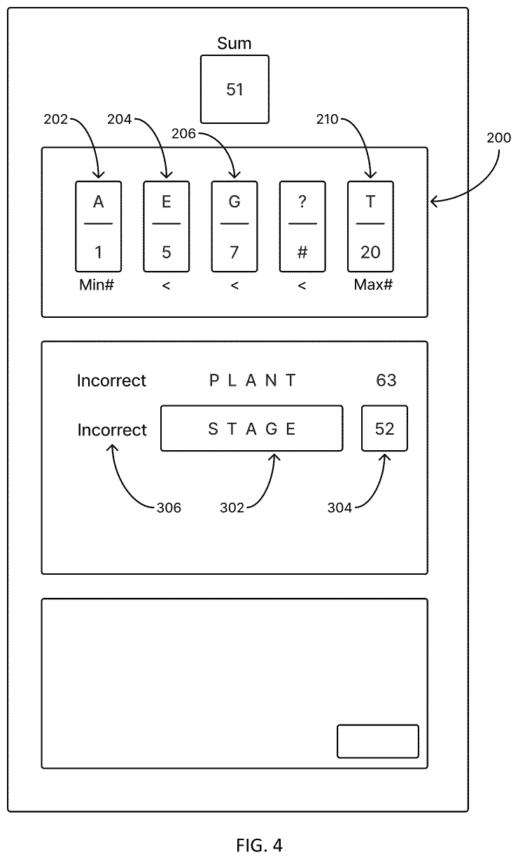

Player's Guess 2: STAGE (S=19, T=20, A=1, G=7, E=5) (see FIG. 4). (1) The game informs the player the guess sum is 52. (2) The game informs the player that “T”, “A”, “G”, and “E” are in the word. (3) A=1 is the smallest (Min) value. (4) E=5 is the second smallest value with 1 letter smaller and 3 letters larger. (5) G=7 is the middle value with 2 letters smaller and 2 letters larger. (6) T=20 is the largest (Max). (7) The game informs the player the word is not correct.

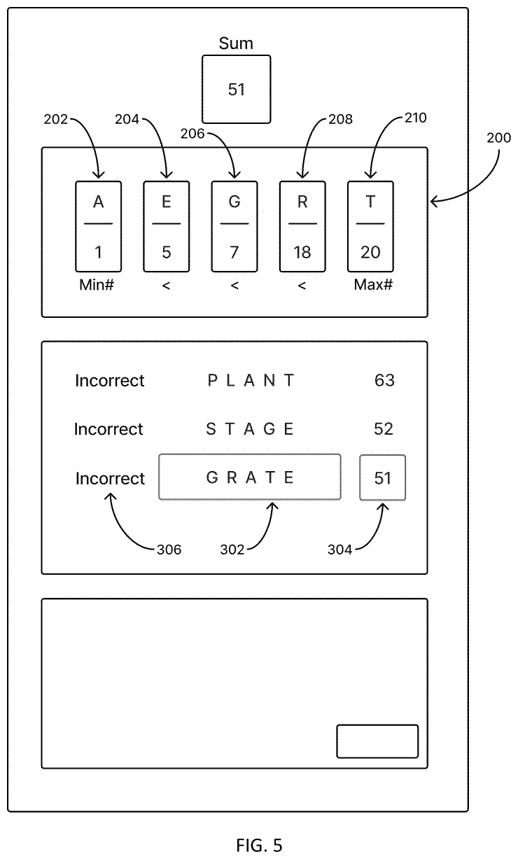

Player's Guess 3: GRATE (G=7, R=18, A=1, T=20, E=5) (see FIG. 5). (1) The game informs the player the guess sum is 51. (2) The game informs the player that all the letters are correct. (3) A=1 is the smallest (Min). (4) E=5 is the second smallest value with 1 letter smaller and 3 letters larger. (5) G=7 is the middle value with 2 letters smaller and 2 letters larger. (6) R=18 is the second largest value with 1 letter larger and 3 letters smaller. (7) T=20 is the largest (Max). (8) The game informs the player the word is not correct.

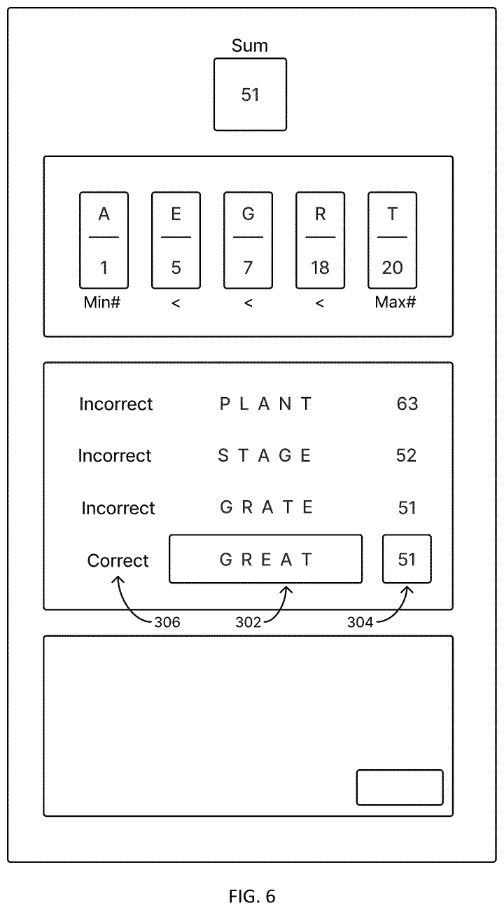

Player's Guess 4: GREAT (G=7, R=18, E=5, A=1, T=20) (see FIG. 6). (1) The game informs the player the guess sum is 51. (2) The game informs the player that all the letters are correct. (3) A=1 is the smallest (Min). (4) E=5 is the second smallest value with 1 letter smaller and 3 letters larger. (5) G=7 is the middle value with 2 letters smaller and 2 letters larger. (6) R=18 is the second largest value with 1 letter larger and 3 letters smaller. (7) T=20 is the largest (Max). (8) The game informs the player the word is correct; the guessed word matches the puzzle word.

### DETAILED DESCRIPTION OF THE DRAWINGS

FIG. 1 is a diagram of a game display screen (100) in an initial state. A target sum display (102) presents the numeric sum of the letters of the hidden puzzle word. A guess area (300) is provided for entry and display of player guesses, a feedback area (200) is available to present information about correct letters and relative positions, a keyboard area (400) is provided to select guess letters and submit a guess. The puzzle word is stored in memory and remains hidden from the player.

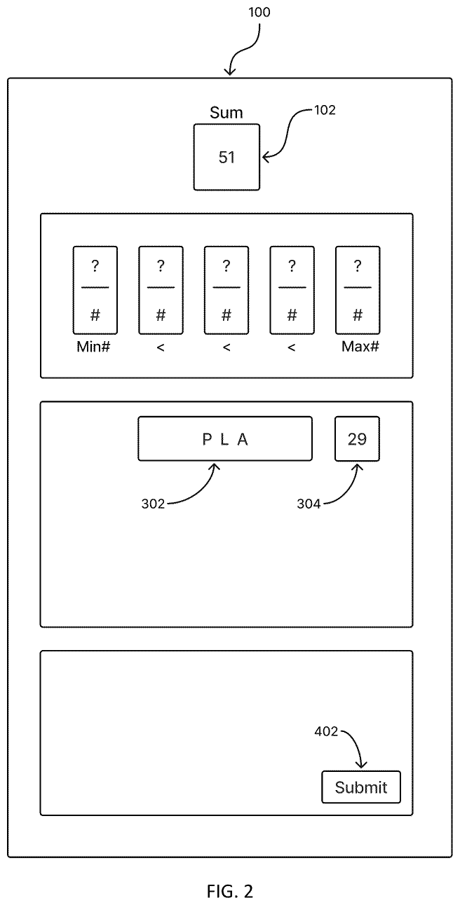

FIG. 2 shows the game display screen (100) after a partial guess has been entered. In this example, letters “P,” “L,” and “A” have been entered into the guess input box (302) and a calculated interim sum (304) is automatically displayed reflecting the sum of the letters entered to that point. A submission control (402) allows the player to submit the guess.

FIG. 3 illustrates the state of the game after a first complete word guess. A submitted guess word such as “PLANT,” is shown in the guess input box (302). The guess word sum of “63” is shown (304). The evaluation of the guess word versus the puzzle word is displayed as “Incorrect” (306). The feedback area (200) shows which of the guess word letters are in the puzzle word and their relative numeric value versus the other letters in the puzzle word, such as identifying “A” equal to “1” as a minimum value (202) and “T” equal to “20” as a maximum value (210).

FIG. 4 shows the state of the game after a second guess word has been submitted. A submitted guess word, such as “STAGE,” is displayed (302) along with the automatically calculated sum of “52” (304). The evaluation of the guess word versus the puzzle word is displayed as “Incorrect” (306). The feedback area (200) reveals the found letters from all guesses and their relative numeric positions. For example, “A” equal to “1” is shown as the minimum letter value (202), “E” equal to “5” as the second smallest letter value (204), “G” equal to “7” as the middle letter value (206), and “T”equal to “20”as the maximum letter value (210).

FIG. 5 shows the state of the game after a third guess word. A submitted guess word, such as “GRATE,” is displayed (302), with the corresponding sum of “51” (304). The evaluation of the guess word versus the puzzle word is displayed as “Incorrect” (306). In this state, all letters are identified as found in the feedback area (200). A full relative mapping of the letters in the puzzle word is displayed, indicating “A” equal to “1” as the minimum value (202), “E” equal to “5” as the second smallest letter value (204), “G” equal to “7” as the middle letter value (206), “R” equal to “18” as the second largest letter value (208), and “T” equal to “20” as maximum letter value (210).

FIG. 6 shows the state of the game after the correct guess is submitted. A submitted guess word, such as “GREAT,”is displayed (302), along with the corresponding sum of “51”(304). The evaluation of the guess word versus the puzzle word is displayed as “Correct” (306) indicating the puzzle word has been successfully identified.

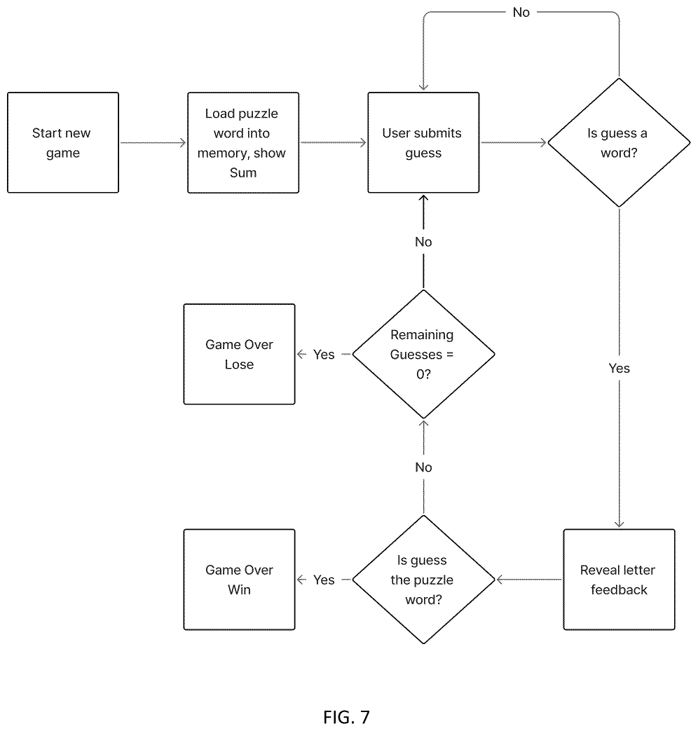

FIG. 7 is a flowchart illustrating the logic of the game. The game initializes with a puzzle word and displays the sum. A player submits a guess which is verified to be an allowed word, feedback is provided regarding the correct letters and their relative positions, and the guess is compared to the puzzle word. The process repeats until the solution is identified or the maximum number of guesses is reached.

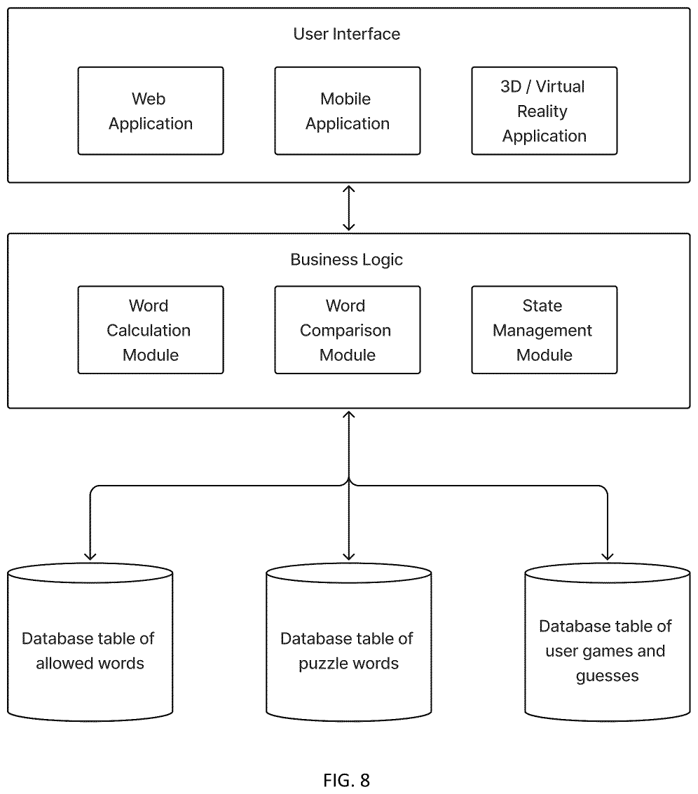

FIG. 8 is a system architecture diagram of the invention. A game player interacts with the game through a User Interface layer, which may be implemented as a web application, a mobile application, a three-dimensional or virtual reality application. The User Interface layer transmits user inputs to a Business Logic layer, which executes instructions and calculations to generate the corresponding gameplay experience. Within this layer, the system calculates numeric sums for guesses and puzzle words, compares letters and words to the puzzle word, provides feedback on relative positions of letters, and manages the overall state of gameplay. The Business Logic layer also manages data retrieval and persistence to underlying databases, including a dictionary of allowable words and a puzzle word repository, and a user gameplay repository, thereby supporting both single-user and multiuser gameplay.

Embodiments: Variations may include different word lengths, guess limits, multiplayer competition, three-dimensional environments, and implementation on mobile devices, desktop computers, or web-based platforms.

Technical Implementation: The invention may be implemented using a processor, memory storing a dictionary of allowable words, a display for presenting the target sum and feedback, an input interface for receiving guesses, and a feedback module. Networked implementations may support multiplayer play.

1. A computer-implemented word guessing game comprising:
a processor configured to assign a numeric value to each letter of an alphabet; a memory storing a plurality of puzzle words, each having a predetermined length;
a display configured to present to a player a target sum corresponding to the sum of the numeric values of the letters of a selected puzzle word;
an input interface enabling the player to submit guess words of the predetermined length; a comparison module configured to calculate the numeric sum of each guess word and determine whether one or more letters of the guess word are present in the puzzle word; and
a feedback module configured to reveal, for each identified letter, its relative numeric position within the puzzle word, including at least one of: a minimum value, a maximum value, and one or more intermediary values between the minimum and maximum values.

2. The game of claim 1, wherein the numeric value of each letter comprises its alphabetical position.

3. The game of claim 1, wherein the predetermined length is five letters.

4. The game of claim 1, wherein the predetermined length is four letters.

5. The game of claim 1, wherein the player is limited to a maximum number of guesses.

6. The game of claim 1, wherein the feedback module further provides the numeric sum of the guess word.

7. The game of claim 1, wherein the feedback module highlights letters that are present in the puzzle word.

8. The game of claim 1, wherein the target sum is displayed before the player submits a first guess.

9. The game of claim 1, wherein the comparison module accesses a dictionary database to validate allowable guess words.

10. The game of claim 1, wherein the display comprises a mobile application interface, a web browser interface, a gaming console interface, or three-dimensional virtual environment.

11. The game of claim 1, wherein the puzzle word is presented in a multiplayer mode in which multiple players attempt to identify the same puzzle word.

12. A method of operating a numerical word guessing game, comprising:
assigning numeric values to each letter of an alphabet; selecting a puzzle word of predetermined length;
determining a target sum equal to a sum of the numeric values of the letters of the puzzle word;
presenting the target sum to a player as an initial hint; receiving, from the player, a guess word;
calculating a numeric sum of the letters of the guess word;
identifying one or more letters of the guess word that are present in the puzzle word; and
providing feedback identifying a relative numeric position of each identified letter within the puzzle word, including whether the letter represents a minimum value, a maximum value, or an intermediary value between the minimum and the maximum.

13. The method of claim 12, further comprising displaying the numeric sum of the guess word to the player.

14. The method of claim 12, wherein the feedback comprises visual or textual clues presented on a graphical user interface.

15. The method of claim 12, wherein the feedback is provided progressively as letters are entered and guesses submitted by the player.

16. The method of claim 12, further comprising limiting the player to a maximum number of guesses to identify the puzzle word.

17. The method of claim 12, wherein multiple players compete simultaneously to solve the same puzzle word.

18. The method of claim 12, wherein the game logic is executed on a mobile device, tablet, desktop, or cloud-based server.

19. A non-transitory computer-readable storage medium storing instructions which, when executed by a processor, cause a computing device to:
assign numeric values to letters of an alphabet;
select a puzzle word and present to a player a target sum equal to the sum of the puzzle word's letters;
receive a guess word from the player; calculate the numeric sum of the guess word;
determine whether one or more letters of the guess word are present in the puzzle word; and
provide feedback to the player identifying relative numeric positions of the letters within the puzzle word, including at least one of a minimum value, maximum value, or intermediary values between the minimum and maximum.
